(19) United States
(12) Patent Application Publication
(10) Pub. No.: US 2025/0129213 A1
(43) Pub. Date: Apr. 24, 2025

(54) SOLUBLE POLYIMIDES FOR COATING ON POLYMERIC SUBSTRATES

(71) Applicant: HD MICROSYSTEMS, Wilmington, DE (US)

(72) Inventors: C. Chad ROBERTS, Wilmington, DE (US); John Donald SUMMERS, Durham, NC (US); Wei LI, Charlotte, NC (US)

(21) Appl. No.: 18/291,335

(22) PCT Filed: Aug. 5, 2022
(86) PCT No.: PCT/US2022/039522

§ 371 Date: Jan. 23, 2024

(51) Int. Cl. C08G 73/10; C08J 7/044; C08K 3/22; C09D 11/033; C09D 11/037; C09D 11/102

(52) U.S. Cl. CPC C08G 73/1053; C08G 73/1032; C08G 73/1071; C08J 7/044; C09D 11/033; C09D 11/037; C09D 11/102; C08J 2379/08; C08J 2467/06; C08K 2003/2241

(57) ABSTRACT

A method comprises providing a substrate, coating onto the substrate a composition comprising 3-30 weight percent based on total weight of the composition of a polyimide; a solvent comprising cyclopentanone in an amount of at least 70, preferably at least 80, more preferably at least 90 weight percent based on total weight of the solvent; and 0-15 weight % of one or more pigments, wherein the polyimide is soluble in the cyclopentanone at room temperature in the range of 5 to 30 weight percent, drying form a solid film on the substrate having a thickness of 1 to 5 micrometers. A composition useful in such method and an article made from such method are also disclosed.

### CROSS-REFERENCE TO RELATED APPLICATIONS

This application claims the benefit of U.S. Provisional Application No. 63/232,746 filed Aug. 13, 2021, the disclosure of which is incorporated herein by reference in its entirety.

### FIELD OF THE INVENTION

The field of this invention is a solution of polyimide and pigment, a method of coating such solution, particularly on polymeric substrates, and a coated polymeric substrate so formed.

### BACKGROUND

Certain polyimides find use as electrically insulating layers or as passivation films, for example in manufacture of integrated circuits. However, polyimides can be expensive. Thus, despite their desirable material properties it can be uneconomical to use them in certain large scale or lower cost applications.

In addition, frequently polyimides films or layers are formed by cure or dehydration of polyamic acids that have been coated onto the substrate. Such cure/dehydration occurs at elevated temperatures that can make the polyimides unsuitable for use as a coating layer on polymers having lower glass transition temperatures (Tg) or melting temperatures (Tm).

A need exists for a polyimide composition that can economically be used in larger scale applications and/or that can be applied to a relatively low Tg or Tm polymeric substrates.

### SUMMARY OF THE INVENTION

Disclosed herein is a method comprising providing a substrate, coating onto the substrate a composition comprising 3-30 weight percent based on total weight of the composition of a polyimide; a solvent comprising cyclopentanone in an amount of at least 70, preferably at least 80, more preferably at least 90 weight percent based on total weight of the solvent; and 0-15 weight % of one or more pigments, wherein the polyimide is soluble in the cyclopentanone at room temperature in the range of 5 to 30 weight percent, drying form a solid film on the substrate having a thickness of 1 to 5 micrometers.

Also disclosed herein is an article made by such method, preferably characterized by one or more of the following characterized by one or more of the following the film has a dielectric constant of 4-10, the film a percent transmission at 400-750 nm of 1-80%, the film has a breakdown voltage of at least 200 volts/micron.

Further disclosed herein is a composition comprising 3-30, preferably 5 to 30, more preferably 5 to 25, yet more preferably 7 to 20, still more preferably 10-15 weight percent based on total weight of the composition of a polyimide; a solvent comprising cyclopentanone in an amount of at least 70, preferably at least 80, more preferably at least 90 weight percent based on total weight of the solvent; and 0-15, preferably 0.05-10, more preferably 0.1 to 5 weight % of one or more pigments, preferably inorganic pigments; and wherein the polyimide is soluble in the cyclopentanone at room temperature in the range of 5 to 30 weight percent.

### DETAILED DESCRIPTION OF THE INVENTION

Disclosed herein is a composition comprising 5-30 wt % of a polyimide and a solvent comprising cyclopentanone, where the polyimide is soluble in the amount at which it is present in the solvent. The composition can further include a pigment in amounts up to 15, or up to 10 weight %. The composition can be free of or substantially free of polyamic acid precursors of the polyimides. The composition can have a viscosity of 100 to 5000 centipoise, or 150 to 2000 centipoise, or 200 to 1500 centipoise, or 250 to 1000 centipoise, or 300 to 600 centipoise. Also disclosed is a method of coating comprising providing the composition and coating, for example by gravure coating, the composition onto a substrate. The present inventors have surprisingly discovered that cyclopentanone is a uniquely effective solvent for a variety of polyimides enabling by a variety of methods including particularly, gravure coating. The substrate can comprise, comprise as a major component, or consist essentially of a polymer, for example a low cost polymer and/or a low Tg or low Tm polymer where the Tg and/or Tm is less than the cure or dehydration temperature for forming the polyimide from a polyamic acid. Also disclosed herein is an article comprising a film of the polyimide on such a substrate.

### The Polyimide

The polyimide component of the composition can provide excellent electrical insulation properties and/or dielectric strength. The polyimide can have a weight average molecular weight of 80,000 to 250,000, or 100,000 to 200,000, or 110,000 to 160,000 grams/mole as determined by gas permeation chromatography with polystyrene molecular weight calibration.

The polyimide can be the reaction product of a reaction mixture including a dianhydride with a polyamine (e.g., a diamine).

The dianhydride can be a dianhydride useful in making polyimides. For example, the dianhydride can be a tetracarboxylic dianhydride such as a cycloaliphatic dianhydrides (e.g., 1,2,3,4-Cyclobutanetetracarboxylic dianhydride (CBDA), Bicyclo[2.2.2]oct-7-ene-2,3,5,6-tetracarboxylic dianhydride (BCODA), or 2,3,5-tricarboxycyclopentyl acetic dianhydride (TCA). As another example the dianhydride can be a diphthalic anhydride. The diphthalic dianhydride can be of the formula

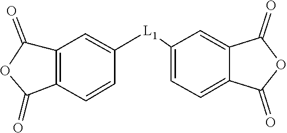

where L1 is a direct bond or a linking group. Examples of linking groups include —O—, substituted (e.g., halogenated, specifically fluorinated) or unsubstituted alkyl groups of 1, 2, 3, or 4 carbon atoms, —O—Ar₁—O—, where Ar₁ is a group comprising one or more aromatic ring. Examples of such dianhydrides include 4,4′-oxydiphthalic anhydride (ODPA), bis(3,4-dicarboxyphenyl)sulfoxide dianhydride (DSDA), 2,2-bis-(3,4-dicarboxyphenyl) 1,1,1,3,3,3,-hexafluoropropane dianhydride (6-FDA) 4,4′-(4,4′-isopropylidenediphenoxy)bis-(phthalic anhydride) (BPADA), 4,4′-oxydiphthalic anhydride (ODPA), bis(3,4-dicarboxyphenyl)sulfoxide dianhydride (DSDA). A combination of dianhydrides can be used. The anhydride(s) is (are) reacted with a polyamine amine to form a polyamic acid.

The anhydrides and amines can be provided in substantially stoichiometric proportions.

Examples of diamines include aromatic diamines and cycloaliphatic diamines. Aromatic diamines can have amine groups on a single aromatic ring or can have two or more aromatic rings. The amine groups on aromatic diamines with more than two aromatic rings can be located on the two end group aromatic rings. Examples of aromatic diamines include m-phenylenediamine (MPD), 3,4′-diaminodiphenyl ether (3,4′-ODA), 4,4′-diamino-2,2′-bis(trifluoromethyl)biphenyl (TFMB), 3,3′-diaminodiphenyl sulfone (3,3′-DDS), 4,4-(hexafluoroisopropylidene)bis(2-aminophenol) (6F-AP), bis-(4-(4-aminophenoxy)phenyl)sulfone (BAPS), 9,9-bis(4-aminophenyl)fluorene (FDA); 2,3,5,6-tetramethyl-1,4-phenylenediamine (DAM), 2,2-bis[4-(4-aminophenoxyphenyl)]propane (BAPP), 2,2-bis[4-(4-aminophenoxyphenyl)]hexafluoropropane (HFBAPP), 1,3-bis(3-aminophenoxy) benzene (APB-133), 2,2-bis(3-aminophenyl)hexafluoropropane, 2,2-bis(4 aminophenyl)hexafluoropropane (bis-A-AF), 4,4′-bis(4-amino-2-trifluoromethylphenoxy) biphenyl; 4,4′-[1,3-phenylenebis(1-methyl-ethylidene)], bisaniline (bisaniline-M), and meta or para xylene diamine. Examples of cycloaliphatic diamines include bis-cycloalkyl amines such as 4,4′-methylenebis(2-methylcyclohexyl-amine) (DMDC) or monocyclic aliphatic diamines such as isophorone diamine (IPDA).

The reaction mixture including dianhydride and diamine in a solvent is reacted to form a polyamic acid. The ratio of total moles of dianhydride: total moles of diamine can be about 1:1. The polyamic acid can be terminated for example with: 3 Amino Phenol, Trimellitic acid anhydride, phallic anhydride, Aniline, methyl aniline, aliphatic amines (such as butyl amine and dodecyl amine) and maleic anhydride.

The polyamic acid is converted to polyimide by dehydration and/or heating. For example, dehydration can occur by addition of one or more dehydrating agents (e.g., acetic anhydride, propionic anhydride, n-butyric anhydride, benzoic anhydride, acetic benzoic anhydride) and a tertiary amine catalyst such as pyridine, 3-picoline, lutidine, dimethyl aniline, 4-dimethyl aminopyridine, trialkyl amines, triethyl amine, quinoline and N-methyl morpholine, and/or by heating to cure to form the polyimide. For example, Chemical dehydration typically can require minimal heating 80° C. or less for 1-2 hours to ensure complete conversion. Alternatively, the poly(amic acid) may be thermally converted to polyimide solution via azeotropic distillation of water from imidization. In this process, 10-15% azeotropic solvent (such as benzene, toluene or xylenes) is added followed by refluxing from several hours at temperatures in range of 130-180 C.

The polyimide can be precipitated to form a powder which is then redispersed in the desired solvent for coating. Alternatively, it is possible in some instances to form the polyimide in the solvent that is desired for coating in which case the precipitation and redissolution can be avoided. The amount of polyimide based on the total weight of the composition can be from 3 to 30%, 5 to 25%, or 7 to 20% or 10 to 15% by weight.

### Solvent

The inventors discovered that cyclopentanone was a surprisingly more effective solvent than many other known solvents. Thus, the solvent comprises cyclopentanone. solvent can consist of cyclopentanone as the only solvent. Alternatively, the solvent can comprise cyclopentanone in an amount of at least 70, at least 80, at least 90, at least 95, at least 98 or at least 99 weight percent with the remainder of the solvent comprising one or more additional compatible solvents. For example, when adding pigment to the composition the pigment may be provided in a dispersion form in a solvent and thus cyclopentanone may not be the sole solvent in the composition. Examples of such additional compatible solvents include alkyl acetates such as ethyl acetate or butyl acetate; alkoxy alkyl acetates, such as 2-methoxyethyl acetate; carbonate esters, such as dimethyl carbonate (DMC); ketones, such as methyl ethyl ketone (MEK), butyrol lactone (BLO), acetophenone; glycol alkyl ethers such as propylene glycol methyl ether; glycol alkyl ether acetates such as propylene glycol methyl ether acetate (PGMEA); alkyl ethers including, cyclic ethers such as tetrahydrofuran (THF), diethers such as dimethoxyethane; triethers; and dimethylsulfoxide (DMSO).

The polyimide is dissolved in the solvent. In the compositions disclosed herein the polyimide preferably is soluble in the solvent. The polyimide can be soluble in the solvent when present in amounts of up to 10 or up to 30 weight percent based on total weight of the polyimide and solvent, and preferably in the amount that it is present in the composition. Specifically, solubility can be confirmed if there is no visibly observed turbidity, haze or particulates at room temperature.

### Pigment

The present inventors have discovered that by adding a pigment one can obtain a film with a higher dielectric constant that the polyimide film itself while still maintaining dielectric strength as indicated for example by breakdown voltage along with good mechanical properties. Thus, the composition can include pigment particles (e.g., inorganic pigments or carbon black) in amounts up to 0-15, or 0.05-10, or 0.1 to 5 wt % based on total weight of the composition.

The present inventors have found that using a soluble polyimide enables incorporation of such pigments. In contrast, the polyamic acids can negatively impact the dispersibility of the pigments. Thus, particularly where pigments are included, the composition preferably is free of or substantially free of polyamic acid. By substantially free of is mean less than 5%, or less than 1%, or less than 0.5% or less than 0.1% polyamic acid based on total amount of polyamic acid and polyimide in the composition as determined by Fourier-transform infrared spectroscopy.

Inorganic pigments have been found to be particularly useful for the present invention. Examples of inorganic pigments include opacifying pigments and colorant pigments. Opacifying pigments have high refractive index which leads to increased light scattering in the coating effectively “hiding” the coated substrate. High refractive index pigment are typically inorganics such as Titanium dioxide, Barium Sulfate, Zinc Sulfide, Zinc Oxide, Calcium Carbonates, silicates, sulfates, and oxides. Inorganic colored pigments include iron oxides (yellow, red, browns), Manganese violet, Pigment Blue 27 & 28 (Iron & Cobalt Blue). Carbon black can be used as a pigment.

Organic pigments can be incorporated to adjust color. Some examples of organic pigments with useful coloristic properties: (cyan) Pigment Blue 15:3 and Pigment Blue 15:4; (magenta); Pigment Red 122 and Pigment Red 202; (yellow) Pigment Yellow 14, Pigment Yellow 74, Pigment Yellow 95, Pigment Yellow 110, Pigment Yellow 114, Pigment Yellow 128 and Pigment Yellow 155; (red) Pigment Orange 5, Pigment Orange 34, Pigment Orange 43, Pigment Orange 62, Pigment Red 17, Pigment Red 49:2, Pigment Red 112, Pigment Red 149, Pigment Red 170, Pigment Red 177, Pigment Red 178, Pigment Red 188, Pigment Red 254, Pigment Red 255, and Pigment Red 264; (green) Pigment Green 1, Pigment Green 2, Pigment Green 7 and Pigment Green 36; (blue) Pigment Blue 60, Pigment Violet 3, Pigment Violet 19, Pigment Violet 23, Pigment Violet 32, Pigment, Violet 36 and Pigment Violet 38.

Other pigments also include exfoliated clays and core-shell latex (air filled) pigments have been used as supplemental hiding/opacifying pigment in combination with inorganics such as TiO2.

A pigment described above can be used alone in the composition or in combination with one or more other pigments.

### Coating and Article

The method disclosed herein comprises providing the composition by coating onto a substrate and drying to remove solvent. The coating can occur by gravure coating, spin coating, bar coating, or the like. The drying can be at a temperature of 50 to 170, or 70 to 150, or 80 to 120° C. The drying temperature can be below the Tg or the Tm of the polymeric substrate. Drying can occur over a time of 1 to up to 30 minutes.

The substrate can be a substrate that includes a low cost or a low Tg or low Tm polymer. The substrate can comprise a low cost film. The substrate can comprise a polymeric film having a Tg and/or Tm of less than 200, or less than 180 or less than 160° C. The substrate can comprise for example, an olefinic polymer such as polyethylene, a polypropylene, and copolymers thereof. The substrate can comprise a styrenic polymer such as polystyrene or copolymers of styrene with one or more other monomers. The polymer of the substrate can be a polyester such as polyethylene terephthalate (PET), poly butylene terephthalate (PBT) or polyethylene naphthaltate (PEN).

The coating (also referred to herein as the film or layer) on the substrate can have a thickness of 0.5 to 20 microns, 1 to 10 microns or 1 to 5 microns. The coating can have a voltage breakdown of at least 100 or at least 200, or at least 250 volts/micron of thickness. The coating can have a dielectric constant of 3-10, or 4-9. The coating can have a transmission (with no pigment added) of at least 90% at a thickness of 3.5 microns as measured on Eagle glass (TM corning glass). The coating (with no pigment added) can have a transmission of at least 92 or at least 95%. Transmission can be determined by using a spectrophotomer such as a HunterLab UltraScan™.

### EXAMPLES

### Example 1—Polyimide Synthesis

A 500-mL round bottom flask equipped with mechanical stirrer a nitrogen purge was loaded with 30.78 g 2,2′-Bis(trifluoromethyl)benzidine) (“TFMB”) and 171.87 g N-Methyl-2-pyrrolidone (NMP) and mixed for 1 hour. Oxydiphthalic Anhydride (ODPA) in an amount of 29.21 g, was added over 4 hours while rinsing with a total of 168.16 g NMP. After stirring overnight, the reaction mixture had a viscosity of 531.8 centipoise (cP), and 0.299 g ODPA was added to adjust the stoichiometry and increase the viscosity. The viscosity was monitored over a total of 5 days and adjusted with a total of 0.733 g ODPA for a final poly (amic acid) solution viscosity of 3026 cP. The poly (amic acid) was chemically converted to polyimide via the addition of 3-picoline (21.44 g) and acetic anhydride (24.04 g) and mixing overnight. The ODPA/TFMB polyimide was precipitated from NMP. After filtering and drying the fine powder at 80° C. under vacuum, a total of 57.81 g was obtained. As measure by relative GPC, this polyimide powder had a weight average molecular weight Mw of about 260,000 g/mol and a polydispersity of 2.82. The glass transition temperature (Tg) was 294.5° C. based on DSC analysis, and TGA exhibited a 5% weight loss at 540.45° C.

This polyimide powder was found by visible inspection at room temperature to be soluble (at least 10% wt with no haze or turbidity) in several volatile solvents potentially suitable for roll-to-roll gravure or slot-die coating including ethyl acetate, MEK, PGMEA (propylene glycol methyl ether acetate), cyclopentanone, 2-methoxyethyl acetate, and THF.

### Example 2

Polyimide inks were formulated by initially dissolving polyimide dried powder as in Example 1 in cyclopentanone at approximately 12 wt. % solids. A dispersion of TiO2 (66% solids in PGMEA and butyl acetate) was then added to polyimide solution, and after mixing overnight, the inks were filtered through 5-micron syringe filter. The Table 1 illustrates several examples suitable for spin coating. Altemative coating processes may require additional dilution. For example, for gravure coating a viscosity of 300 to 600 centipoise can be used.

TABLE 1

| | 11.76% PI-1 | Gibraltar 955- | | | | |
|---|---|---|---|---|---|---|
| | (above) in | 39600 TiO2 | | | Total | |
| Ink | cyclopentanone | dispersion (66%) | Wt. % | Wt % | Solids, | Viscosity, |
| ID | (parts by weight) | (Parts by weight) | PI | TiO2 | wt % | cP |
| 1A | 76.44 | 3.59 | 11.2 | 3.0 | 14.2 | 2081 |
| 1B | 74.53 | 5.46 | 11.0 | 4.5 | 15.5 | 2124 |
| 1C | 72.43 | 7.59 | 10.6 | 6.3 | 16.9 | 2352 |
| 1D | 70.33 | 9.67 | 10.3 | 8.0 | 18.3 | 2344 |

Films coated from the Inks at about 10 microns were tested for dielectric constant and breakdown voltage using Dielectric Withstand or Hipot (High Potential) Tester according to ASTM D149 IEC60243. Films of 3-5 micron thickness on Eagle glass substrate having a % transmission of 92.01 and L*,a*,b* of 96.833, −0.004, and 0.146, respectively, were tested for color and transmission using Hunter Lab Ultra Scan XE Spectro-Colorimeter. The Table 2 summarizes the data.

TABLE 2

| | | | | Average % | | | |
|---|---|---|---|---|---|---|---|
| | Dielectric | | | Transmission, | | | |
| | Constant, | Breakdown | Thickness | 400-750 nm, 3.5 | | | |
| Ink | Dk (10 | Voltage, | of film, | micron on Eagle | | | |
| ID | GHz) | V/micron | microns | Glass | L* | a* | b* |
| Clear | 3.42 | 253 | 10.8 | 90.01 | 96.06 | −0.016 | 0.5 |
| 1A | 4.30 | 309 | 8.5 | 49.89 | 94.38 | −1.223 | 1.480 |
| 1B | 5.02 | 308 | 9.3 | 46.17 | 94.49 | −1.246 | 1.936 |
| 1C | 5.30 | 253 | 10.0 | 41.20 | 94.82 | −1.170 | 1.733 |
| 1D | 5.80 | 237 | 11.4 | 40.42 | 94.99 | −1.148 | 1.640 |

The data above demonstrates that films with added white pigment (TiO2) have increased dielectric constant for improved electrical performance in capacitance applications while maintaining high breakdown voltage and providing opacity/color for aesthetics.

### Example 3

Various polyimides were made substantially according to the procedure of Example 1 but using anhydride compounds and amine compounds set forth below.

| Polyimide ID | Dianhydride used | Diamine used |
|---|---|---|
| 1 | BPADA* | TFMB⁺ |
| 2 | ODPA^{#} | TFMB |
| 3 | BPADA | DMDC** |
| 4 | ODPA | DMDC |
| 5 | BPADA | DDS^{##} |
| 6 | BPADA | BAPP⁺⁺ |
| 7 | BPADA | BisP*** |
| 8 | ODPA | DDS and BisP |
| 9 | CBDA^{###} | DMDC |
| 10 | TAHQ⁺⁺⁺ | DDS and BisP |

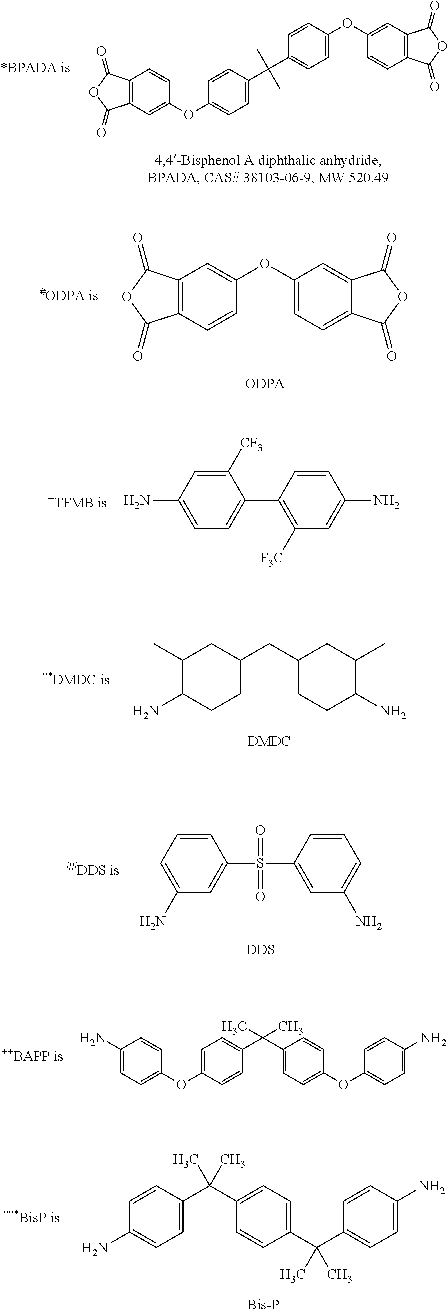

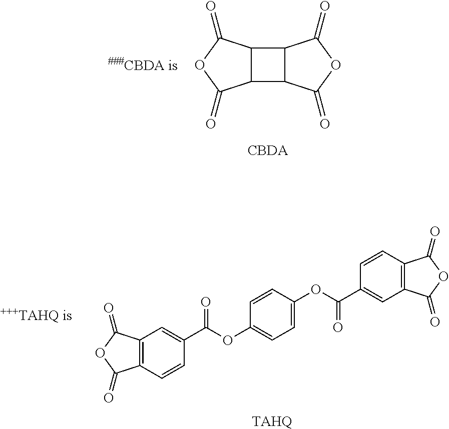

The polyimides were then tested for solubility in the various solvents by mixing 0.5 grams of polyimide in 4.5 grams of solvent (10 wt %) and by vortexing and rolling overnight. Solubility was determined by visual inspection for cloudiness (turbidity) or precipitation. Cyclopentanone was found to be an effective solvent for Polyimides 1 and 3-10. In comparison, solvents having similar boiling points-in the range of 100-150 were not as effective. Specifically, PGMEA with a boiling point of 146° C. was not effective for polyimides 2-3 and 5-7 (not tested for PI 8-10). Methoxyethylacetate (B.P. 145° C.) was effective only for polyimides 1 and 3-4. PGME (B.P. 120° C.) was effective only for polyimide 1 (was not tested for PI 5-10). Ethyl lactate (BP 151-155° C.) was only an effective solvent for polyimide 1 but not for polyimides 4 and 5 (not tested for other polyimides). Lower boiling point solvents were also less effective. Specifically, dimethylcarbonate (BP 90° C.) was effective for polyimides 4-5 but not polyimides 6-10. Methyl ethyl ketone (BP 80° C.) and ethyl acetate (BP 77° C.) were effective only for PI 1 and 4 but not PI 2-3 and 5-10. THF (BP 66° C.) was an effective solvent only for polyimides 1, 4-5 and 7-10 but not for polyimides 2-3 and 6.

### Example 4

Into a 2 liter reaction flask equipped with a nitrogen inlet and outlet, mechanical stirrer, and thermocouple were charged 67.20 g of trifluoromethyl benzidine (TFMB) and 400 g of 1-methyl-2-pyrrolidinone (NMP). The mixture was agitated under nitrogen at room temperature for about 30 minutes to dissolve the TFMB. Afterwards, 6.17 g of 3,3′4,4-biphenyl tetracarboxylic dianhydride (BPDA) was added slowly in portions to the stirring solution of the diamine followed by 18.64 g 6FDA (hexafluoroisopropylidene dianhydride) in portions. After this, 27.98 g cyclobutane dianhydride (CBDA) was added to the reaction with stirring. The addition rate of the dianhydrides was controlled, so as to keep the maximum reaction temperature under 40° C. After completion of the dianhydride addition, and additional 280 g of NMP was used to wash in any remaining dianhydride powder from containers and the walls of the reaction flask. The dianhydrides dissolved and reacted and the polyamic acid (PAA) solution was stirred for ˜24 hr. After this, CBDA was added in 0.20 g increments to raise the molecular weight of the polymer and viscosity of the polymer solution in a controlled manner. Brookfield cone and plate viscometry was used to monitor the solution viscosity by removing small samples from the reaction flask for testing. A total of 0.60 g of CBDA was added. The reaction proceeded for an additional 48 hours at room temperature under gentle agitation to allow for polymer equilibration. Final viscosity of the polymer solution was 5368 centipoise at 25° C.

To this poly(amic acid) solution was added 44.7 g acetic anhydride with stirring followed by 34.6 g of pyridine. This solution was stirred overnight to covert the poly(amic acid) to the corresponding soluble polyimide. The polymer was isolated by pouring the solution into excess water to precipitate the polyimide as a white fibrous solid. The polymer was isolated by filtration and washed three times with water followed by a final wash of methanol. The polyimide powder was then dried in a vacuum oven overnight at 80 C.

The dried polyimide powder, 26.5 g, was dissolved in 228 g of cyclopentanone using a jar roller. After this, 10.6 g TiO2 white pigment dispersion (Gibraltar Chemical, catalog number 955-39600) was added to the polymer solution with stirring. The coating solution was then pressure filtered through a Whatman Poly Cap HD 5.0 μm absolute filter into an EFD Nordsen dispensing syringe barrel. The solution viscosity was 1240 centipoise.

A syringe barrel was attached to an EFD Nordsen dispensing unit to apply several ml of polymer solution directly onto single-sided metallized polyethylene naphthalene (PEN) film. The coating solution was applied directly to aluminum side of the metallized PEN. A draw-down bar was then used to prepare a uniform coating. The coating thickness was adjusted to prepare a coating with a final cured thickness target of three microns. After the draw-down process, the coating was dried in a forced air convection oven at 130 C for 5 minutes. The average final coating thickness was measured to be 3.1 microns using a hand-held micrometer.

The dielectric coating prepared above was uniform and white in appearance. The volume percent of TiO2 in the dried polyimide coating was calculated to be 9.1 percent. The coating color based on the L*/a*/b* format was determined using a colorimeter to be 74.8/−1.42/−4.26. The average dielectric breakdown voltage as determined by several measurements across the area of the coating using a single point probe was 1830 volts. This translates to a dielectric strength of approximately 590 volts/micron.

This disclosure further encompasses the following aspects.

Aspect 1: A method comprising providing a substrate, coating onto the substrate a composition comprising 3-30, preferably 5 to 30, more preferably 5 to 25, yet more preferably 7 to 20, still more preferably 10-15, weight percent based on total weight of the composition of a polyimide; a solvent comprising cyclopentanone in an amount of at least 70, preferably at least 80, more preferably at least 90 weight percent based on total weight of the solvent; and 0-15 preferably 0.05-10, more preferably 0.1 to 5 weight % based on total weight of the composition of one or more pigments, wherein the polyimide is soluble in the cyclopentanone at room temperature in the range of 5 to 30 weight percent, drying form a solid film on the substrate having a thickness of 1 to 5 micrometers.

Aspect 2: The method of Aspect 1 wherein the coating comprises gravure coating.

Aspect 3: The method of Aspect 1 or 2 where the substrate comprises a flexible polymeric substrate.

Aspect 4: The method of Aspect 3 wherein the flexible polymeric substrate comprises polyethylene terephthalate or polyethylene naphthalene.

Aspect 5: The method of any one of Aspects 3-4 wherein the substrate comprises a conductive layer.

Aspect 6: The method of any one of the preceding Aspects wherein the pigment is present in an amount of 0.1 to 5 weight percent.

Aspect 7: The method any one of the preceding Aspects wherein drying occurs at a temperature of 50 to 170° C., preferably 70 to 150° C., more preferably 80 to 120° C.

Aspect 8: The method of any one of the preceding Aspects where drying occurs over 1 to up to 30 minutes.

Aspect 9: The method of any one of the preceding Aspects wherein the pigment is an inorganic pigment.

Aspect 10: The method of Aspect 8 wherein the pigment comprises Titanium dioxide, Barium Sulfate, Zinc Sulfide, Zinc Oxide, Calcium Carbonates, silicates, sulfates, and oxides. Inorganic colored pigments include iron oxides (yellow, red, browns), Manganese violet, Pigment Blue 27 & 28 (Iron & Cobalt Blue), carbon black; preferably titanium dioxide.

Aspect 11: An article made by the method of any one of Aspects 1-10.

Aspect 12: The article of Aspect 11 characterized by one or more of the following the film has a dielectric constant of 4-10, the film a percent transmission at 400-750 nm of 1-80%, the film has a breakdown voltage of at least 200 volts/micron.

Aspect 13: A composition comprising 3-30, preferably 5 to 30, more preferably 5 to 25, yet more preferably 7 to 20, still more preferably 10-15 weight percent based on total weight of the composition of a polyimide; a solvent comprising cyclopentanone in an amount of at least 70, preferably at least 80, more preferably at least 90 weight percent based on total weight of the solvent; and 0-15, preferably 0.05-10, more preferably 0.1 to 5 weight % of one or more pigments; and wherein the polyimide is soluble in the cyclopentanone at room temperature in the range of 5 to 30 weight percent.

Aspect 14: The composition of Aspect 13 wherein the pigment is an inorganic pigment.

Aspect 15: The composition of Aspect 14 wherein the inorganic pigment is selected from as Titanium dioxide, Barium Sulfate, Zinc Sulfide, Zinc Oxide, Calcium Carbonates, silicates, sulfates, and oxides. Inorganic colored pigments include iron oxides (yellow, red, browns), Manganese violet, Pigment Blue 27 & 28 (Iron & Cobalt Blue), carbon black.

Aspect 16: The composition of any one of Aspects 13-15 having a viscosity of 200 to 2000 centipoise, preferably 300 to 600 centipoise.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). Moreover, stated upper and lower limits can be combined to form ranges (e.g., “at least 1 or at least 2 weight percent” and “up to 10 or 5 weight percent” can be combined as the ranges “1 to 10 weight percent”, or “1 to 5 weight percent” or “2 to 10 weight percent” or “2 to 5 weight percent”).

The disclosure may alternately comprise, consist of, or consist essentially of, any appropriate components herein disclosed. The disclosure may additionally, or alternatively, be formulated so as to be devoid, or substantially free, of any components, materials, ingredients, adjuvants or species used in the prior art compositions or that are otherwise not necessary to the achievement of the function and/or objectives of the present disclosure.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

Unless specified to the contrary herein, all test standards are the most recent standard in effect as of the filing date of this application, or, if priority is claimed, the filing date of the earliest priority application in which the test standard appears.

1. A method comprising providing a substrate, coating onto the substrate a composition comprising 3-30 weight percent based on total weight of the composition of a polyimide; a solvent comprising cyclopentanone in an amount of at least 70 weight percent based on total weight of the solvent; and 0.1-15 weight % of one or more pigments, wherein the polyimide is soluble in the cyclopentanone at room temperature in the range of 5 to 30 weight percent, drying to form a solid film on the substrate having a thickness of 1 to 5 micrometers, a dielectric constant of 4-10, a percent transmission at 400-750 nm of 1-80%, and a breakdown voltage of at least 200 volts/micron.

2. The method of claim 1 wherein the coating comprises gravure coating.

3. The method of claim 1 where the substrate comprises a flexible polymeric substrate.

4. The method of claim 3 wherein the flexible polymeric substrate comprises polyethylene terephthalate or polyethylene naphthalene.

5. The method of claim 3 wherein the substrate comprises a conductive layer.

6. The method of claim 1 wherein the pigment is present in an amount of 0.1 to 5 weight percent.

7. The method of claim 1 wherein drying occurs at a temperature of 50 to 170° C.

8. The method of claim 1 wherein the pigment is an inorganic pigment.

9. The method of claim 8 wherein the pigment is selected from as Titanium dioxide, Barium Sulfate, Zinc Sulfide, Zinc Oxide, Calcium Carbonates, silicates, sulfates, and oxides. Inorganic colored pigments include iron oxides (yellow, red, browns), Manganese violet, Pigment Blue 27 & 28 (Iron & Cobalt Blue), carbon black.

10. An article made by the method of claim 1 characterized by one or more of the following
a. the film has a dielectric constant of 4-10,
b. the film a percent transmission at 400-750 nm of 1-80%,
c. the film has a breakdown voltage of at least 200 volts/micron.

11. A composition comprising
a. 5-30 weight percent based on total weight of the composition of a polyimide;
b. a solvent comprising cyclopentanone in an amount of at least 70 weight percent based on total weight of the solvent; and
c. 0.1-15 weight % based on total weight of the composition of one or more pigments, wherein the polyimide is soluble in the cyclopentanone at room temperature in the range of 5 to 30 weight percent.

12. The composition of claim 11 wherein the pigment is an inorganic pigment.

13. The composition of claim 12 wherein the inorganic pigment is selected from as Titanium dioxide, Barium Sulfate, Zinc Sulfide, Zinc Oxide, Calcium Carbonates, silicates, sulfates, and oxides. Inorganic colored pigments include iron oxides (yellow, red, browns), Manganese violet, Pigment Blue 27 & 28 (Iron & Cobalt Blue), carbon black.

14. The composition of claim 11 having a viscosity of 200 to 2000 centipoise.
